(19) United States
(12) Patent Application Publication
(10) Pub. No.: US 2010/0174986 A1
(43) Pub. Date: Jul. 8, 2010

(54) APPARATUS AND METHOD FOR MOVING TO PREVIOUS WEBSITE IN WEB BROWSER

(75) Inventors: Do-Kyou LEE, Gyeonggi-do (KR); Ick-Bae JUN, Seoul (KR); Jong-Jin BAE, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/647,670

(22) Filed: Dec. 28, 2009

(30) Foreign Application Priority Data
Jan. 5, 2009 (KR) 10-2009-0000451

(51) Int. Cl. G06F 3/01

(52) U.S. Cl. 715/702; 715/760

(57) ABSTRACT

An apparatus and a method for moving a web page in a web browser of a terminal that permits root domain movement by a single input. The apparatus includes a memory, a controller, and a display unit. The memory stores a first list for managing a root domain movement history, and a second list for managing a page movement history. The controller updates at least one of the first list and the second list whenever a web page access occurs, and when moving root domain is selected by a user, directly accesses a web page of the root domain with reference to the first list. The display unit displays the accessed web page.

### CLAIM OF PRIORITY

This application claims the benefit of priority under 35 U.S.C. §119(a) from a Korean patent application filed in the Korean Intellectual Property Office on Jan. 5, 2009 and assigned Serial No. 10-2009-0000451, the entire disclosure of which is hereby incorporated by reference in its entirety.

### BACKGROUND OF THE INVENTION

1. Field of the Invention

The present invention relates to an apparatus and a method for moving to a previous website in a web browser. More particularly, the present invention relates to an apparatus and a method for moving to a webpage that has been previously opened without having to retype URL strings.

2. Description of the Related Art

Generally, in a web browser of a terminal, such as a mobile phone with Internet access or a Personal Computer (PC), a user accesses a web server associated with a relevant webpage identified by a Uniform Resource Locator (URL) to obtain an Hyper Text Markup Language (HTML) file, and displays a web page of sentences or images on a screen by inputting in person a URL to be accessed, or calling a URL registered in a bookmark in advance.

A URL provides indicating a location of a file existing in each server providing a service on a web, and includes a kind of a service to be accessed, a location of a server (domain name), and a location of a file. A general syntax of a URL is ‘protocol://domain name/directory name/file name’. Currently, in a Domain Name System (DNS) hierarchy, a domain name includes a Top-Level Domain (TLD) and a second-level domain. The TLD may be classified into a generic TLD such as corn, net, gov, and edu, and a national TLD such as kr, jp, and cn, for Korea, Japan, and China, respectively. The second-level domain includes a word representing an Internet site name such as Yahoo, Google, and the like when a TLD is a generic TLD. The second-level domain includes a word representing an attribute of a site often used to identify the type of the organization such as co, ac, go, and the like when a TLD is a national TLD. Therefore, when a TLD is a national TLD, a domain name includes a third-level domain including a word representing an Internet site name in addition to a second-level domain. A domain name including a generic TLD and a second-level domain, or a national TLD, a second-level domain, and a third-level domain is also called a root domain. A third level domain often refers to a specific server within an organization. In very large companies or groups, it is possible that division or departments may have respective third level domain, in order to provide a way for identification. Typically, “www” is a default third-level domain name and the most common. Domains whose root domains are the same and whose third-level or fourth-level domains are different are also called sub-domains. For example, ‘naver.com’ is a root domain, and ‘cafe.naver.com’ and ‘mail. naver.com’ are sub-domains.

A general web browser has a function for moving backward and another function for moving forward, both functions associated with paging through a website or websites. The moving backward function is a function for moving to a previously viewed page of a current web page. The moving forward function is a function for moving forward when a web page has moved backward. As described above, only functions for moving to a previous page exist and lots of manipulations are required in order to move to a previous site. In addition, in the case where there are many pages that have been opened and so a previous site has been deleted from a history, backward movement itself is impossible.

Some of browsers store all pages that have been opened by a user in a viewable history, and provide the user with a list of the pages in an order/sequence of how they were previously accessed. In fact, the industry often refers to such a sequence as “footprints” because the user (or another user viewing this in the browser history) will show the path of sites/pages that were previously viewed. Therefore, the user can find out and move to a previously opened page by viewing the list of previously visited sites even without using the moving backward/forward functions. However, since such a list shows only titles of web pages, the user cannot easily recognize whether a particular web page is a site the user desires to view or a different site. Therefore, a method for allowing a user to easily move to a website that has been previously opened as in the moving forward/backward functions needs to be provided.

### SUMMARY OF THE INVENTION

An aspect of the present invention is to provide an apparatus and a method for easily moving to a previous website in a web browser.

Another aspect of the present invention is to provide an apparatus and a method for managing a root domain movement history in a terminal allowing web browsing.

Still another aspect of the present invention is to provide an apparatus and a method for storing a root domain movement history and directly moving to a previous root domain using the stored root domain movement history in a terminal allowing web browsing.

In accordance with an exemplary aspect of the present invention, a method for moving to a web page in a web browser of a terminal includes receiving an input related to web page movement, determining whether the received input related to the web page movement is an input related to moving backward or forward, when the received input related to the web page movement is not the input related to moving backward or forward, comparing a current root domain with a root domain of a web page to be moved to determine whether the root domain has changed, when the root domain has changed, storing an address of the web page to be moved in a first storing unit and a second storing unit, and moving to the web page to be moved.

In accordance with another exemplary aspect of the present invention, an apparatus for moving to a web page in a web browser of a terminal is provided. The apparatus includes a memory for storing a first list for managing a root domain movement history, and a second list for managing a page movement history, a controller for updating at least one of the first list and the second list whenever a web page access occurs, and when a moving root domain is selected by a user, directly accessing a web page of the root domain with reference to the first list, and a display unit for displaying the accessed web page.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is an overview of a terminal allowing web browsing according to an exemplary embodiment of the present invention;

FIG. 2 is a flowchart illustrating a web page moving method of a terminal according to an exemplary embodiment of the present invention;

FIG. 3 is a flowchart illustrating a web page moving method of a terminal according to an exemplary embodiment of the present invention; and

FIG. 4 is a table illustrating an application of a web page moving method of a terminal according to an exemplary embodiment of the present invention.

Throughout the drawings, like reference numerals will be understood to refer to like parts, components and structures.

### DETAILED DESCRIPTION

The following description with reference to the accompanying drawings is provided to assist a person of ordinary skill in the art with a comprehensive understanding of exemplary embodiments of the invention as defined by the claims and their equivalents. The description includes various specific details to assist in that understanding but these are to be regarded as merely exemplary. Accordingly, those of ordinary skill in the art will recognize that various changes and modifications of the exemplary embodiments described herein can be made without departing from the scope and spirit of the claimed invention. Also, descriptions of well-known functions and constructions may be omitted for clarity and conciseness when their inclusion might obscure appreciation of the subject matter of the present invention by a person of ordinary skill in the art.

The terms and words used in the following description and claims are not limited to the bibliographical meanings, but, are merely used by the inventor to enable a clear and consistent understanding of the invention. Accordingly, it should be apparent to those of ordinary skill in the art that the following description of exemplary embodiments of the present invention are provided for illustration purposes only and not for the purpose of limiting the invention as defined by the appended claims and their equivalents.

Exemplary embodiments of the present invention illustrate a technique for managing web pages of a root domain accessed by a user accessing a list, and directly moving to a previous root domain using the list in a terminal allowing web browsing.

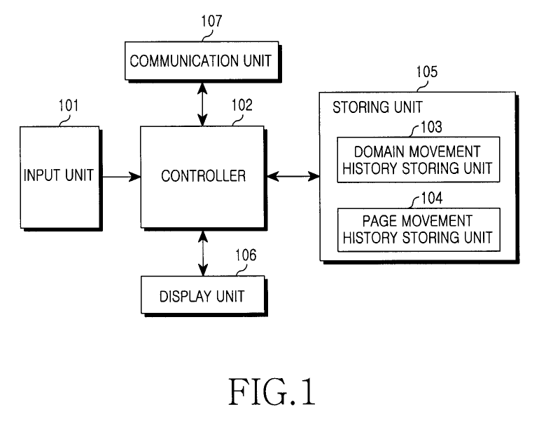

FIG. 1 is a view illustrating a terminal allowing web browsing according to an exemplary embodiment of the present invention.

Referring now to the illustration of FIG. 1, the terminal preferably includes an input unit 101, a controller 102, a storing unit 105, a display unit 106, and a communication unit 107. Here, the storing unit 105 includes a domain movement history storing unit 103 and a page movement history storing unit 104.

The input unit 101 transfers to the controller 102 commands/keystrokes of the user accessing a key button or a touchscreen, a touchpad, a microphone, etc. The controller 102 transmits/receives web page related data to/from the communication unit 107 to allow a web browser to execute a web page. In addition, the controller 102 provides image data to the display unit 106 so that the display unit 106 may display a web page. When a web page movement related input is received from the input unit 101, the controller 102 determines whether or not the input is at least one of moving a page backward/forward and moving a domain backward/forward. When the input is not at least one of moving a page backward/forward and moving a domain backward/forward, for example, when an access of a different page linked to a current page by a user's click of hypertext, or by an access of a different page by a user's URL input is detected, the controller 102 compares a current root domain with a root domain of a web page to be moved, when the root domain has changed, stores information of the web page to be moved in the domain movement history storing unit 103 and the page movement history storing unit 104, and when the root domain does not change, stores the information of the web page to be moved in the page movement history storing unit 104. In addition, when the input is at least one of moving a page backward/forward and moving a domain backward/forward, the controller 102 determines which one of moving a page backward/forward or moving a domain backward/forward is the input. When the input unit requests moving a domain backward/forward, the controller 102 controls to move to a web page of a relevant root domain according to the user's input with reference to the domain movement history storing unit 103. When the input unit requests moving a page backward/forward, the controller 102 controls to move to a relevant web page according to the user's input with reference to the page movement history storing unit 104.

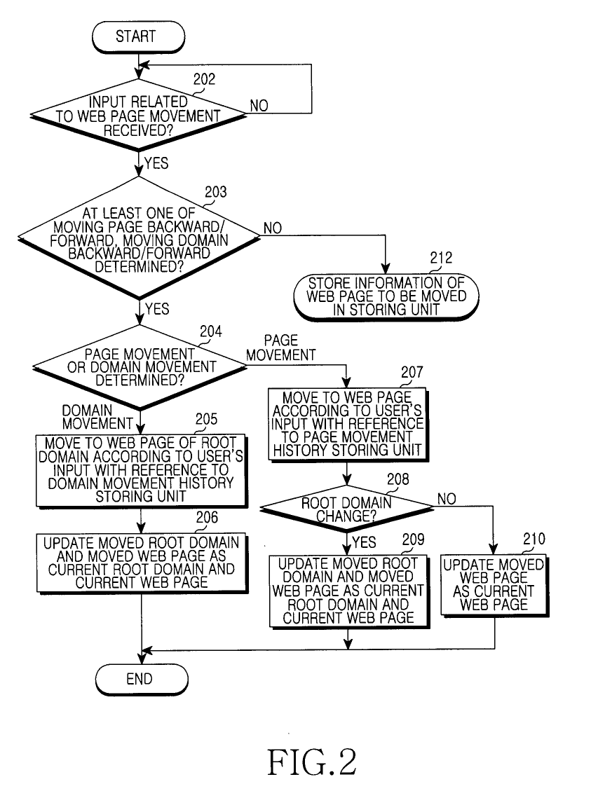

FIG. 2 is a flowchart illustrating a web page moving method of a terminal according to an exemplary embodiment of the present invention.

Referring now to FIG. 2, when a user accesses a web browser, the controller 102 generates or updates the page movement history storing unit 104 for storing a web browser movement history and the domain movement history storing unit 103 for storing only a root domain movement history of movement histories of the web browser in the storing unit 105.

At step 202, the controller 102 determines whether an input related to a user's web page movement is received from the input unit 101. The user's input related to web page movement may be moving a page backward, moving a page forward, moving a domain backward, moving a domain forward, hyperlink selection by a user, direct input of a web page address, selection from favorites, and input of a specific value by a user.

When an input related to the user's web page movement is received, the controller 102 moves to step 203. The controller 102 determines whether the input is at least one of moving a page backward/forward and moving a domain backward/forward in step 203. When at step 203 it is determined that the input is at least one of moving a page backward/forward and moving a domain backward/forward, at step 204 the controller 102 determines which type of input is requested, the moving of a page backward/forward or moving a domain backward/forward according to the user's input.

At step 205, when the user's input is moving a domain backward/forward, the controller 102 moves to a web page of a relevant root domain according to the user's input with reference to the domain movement history storing unit 103. At this point, whenever an input related to the user's page movement is received, the controller 102 can move directly to a previous root domain.

For another example, the controller 102 may display a root domain list, and directly move to one of the root domains on the list according to the user's selection. After moving to a web page of the relevant root domain, at step 206, the controller 102 updates the moved root domain and the moved web page as a current root domain and a current web page.

With continued reference to the flowchart in FIG. 2, at step 207 when the user's input moves a page backward/forward, the controller 102 moves to a web page according to the user's input with reference to the page movement history storing unit 104. In addition at step 208, the controller 102 determines whether the root domain of the web page to be moved changes from a root domain of a current web page. At step 209, when the root domain of the web page to be moved changes from the root domain of the current web page, the controller 102 updates the moved root domain and the moved web page as a current root domain and a current web page. In contrast, when the root domain of the web page does not change, the controller 102 updates the moved web page as a current web page in step 210.

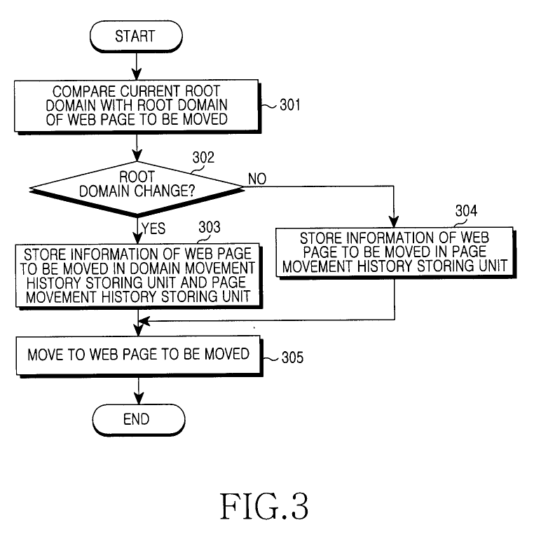

Referring back to step 203, when the user's input is not at least one of moving a page backward/forward and moving a domain backward/forward in step 203, the controller 102 stores information of a web page to be moved in the storing unit 105 in step 212. A detailed operation of step 212 is described below in more detail with reference to FIG. 3.

After that, the controller 102 ends the algorithm according to this particular exemplary embodiment of the present invention.

FIG. 3 is a flowchart illustrating a web page moving method of a terminal according to an exemplary embodiment of the present invention.

Referring now to FIG. 3, the controller 102 compares a root domain of a current web page with a root domain of a web page to be moved in step 301.

In addition, at step 302 the controller 102 determines whether or not the root domain of the web page to be moved changes from the root domain of the current web page.

When the root domain changes, at step 303 the controller 102 stores information of the web page to be moved in the domain movement history storing unit 103 and the page movement history storing unit 104. In addition, the controller 102 moves to the web page to be moved at step 305.

However, when at step 302 the root domain does not change, the controller 102 stores the information of the web page to be moved in the page movement history storing unit 104 in step 304, and moves to the web page to be moved in step 305.

After that, the controller 102 ends the algorithm according to this particular exemplary embodiment of the present invention.

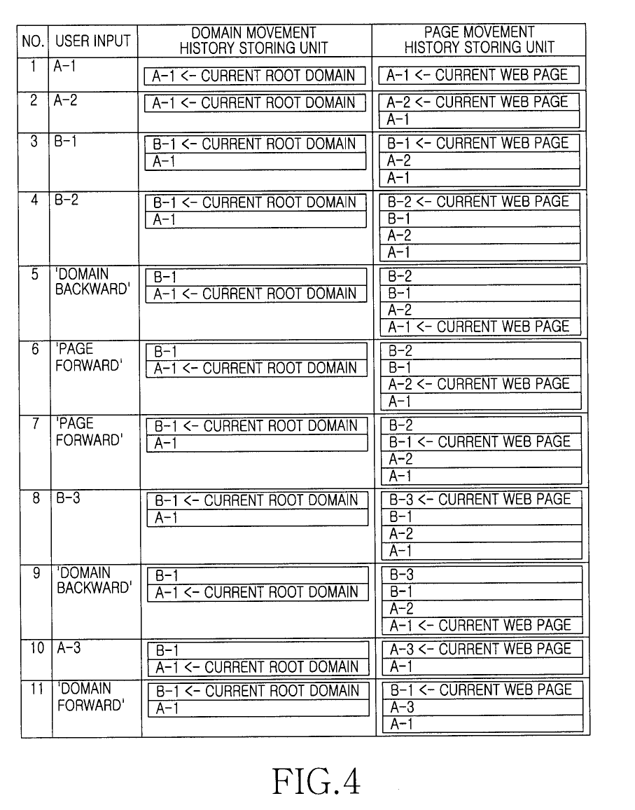

FIG. 4 is a table illustrating an application of a web page moving method of a terminal according to an exemplary embodiment of the present invention. More particularly, FIG. 4 schematically illustrates states of the page movement history storing unit 104 and the domain movement history storing unit 103 on the assumption that a user's inputs are performed in a numbered sequence.

Referring now to FIG. 4, when the user inputs moving to a web page 1 (referred to as A−1) of a root domain A, the controller 102 stores information representing an address of A−1, and that A is a current root domain in the domain movement history storing unit 103, and stores information representing an address of A−1, and (A−1) is a current page in the page movement history storing unit 104.

When the user inputs moving to (A−2), the controller 102 stores information representing an address of (A−2), and (A−2) is a current page and relation information between (A−1) and (A−2) in the page movement history storing unit 104. When the user inputs moving to (B−1), the controller 102 stores information representing an address of (B−1), and that B is now a current root domain, and relation information between A and B in the domain movement history storing unit 103, and stores information representing an address of (B−1), and (B−1) is a current page, and relation information between (A−2) and (B−1) in the page movement history storing unit 104. When the user inputs moving to (B−2), the controller 102 stores information representing an address of (B−2), and (B−2) is a current page, and relation information between (B−1) and (B−2) in the page movement history storing unit 104. When the user inputs ‘moving a domain backward’, the controller 102 displays a specific page (A−1) of A, which is a previous root domain of a current root domain B, on the display unit 106 with reference to the domain movement history storing unit 103, and stores information representing A is a current root domain in the domain movement history storing unit 103. The specific page may be at least one of a page opened many times by users, a page opened last, a page opened first of pages of a root domain A, and a main page of the root domain A stored in the domain movement history storing unit 103. The controller 102 stores information representing the (A−1) is a current page in the page movement history storing unit 104. When a user inputs ‘moving a page forward’ as in number 6, the controller 102 displays (A−2), which is the next page of (A−1), on the display unit 106 with reference to the page movement history storing unit 104, and stores information representing (A−2) is a current page in the page movement history storing unit 104. When a user inputs ‘moving a page forward’ one more time, the controller 102 displays (B−1), which is the next page of (A−2), on the display unit 106 with reference to the page movement history storing unit 104, and stores information representing (B−1) is a current page in the page movement history storing unit 104. Here, since a root domain has changed according to ‘moving a page forward’, the controller 102 stores B, which is the next root domain of the current root domain A, as a current root domain in the domain movement history storing unit 103. When a user inputs ‘moving from (B−1) to (B−3)’ as in a user's input of number 8, the controller 102 can store information representing an address of (B−3), and (B−3) is a current page, and relation information between (B−1) and (B-3) in the page movement history storing unit 104. When a user's input is ‘moving a domain backward’ as in a user's input of number 9, the controller 102 displays a specific page (A−1) of a previous root domain A of a current root domain B, on the display unit 106 with reference to the domain movement history storing unit 103, and stores information representing A is a current root domain in the domain movement history storing unit 103.

In addition, the controller 102 stores information representing (A−1) (FIG. 4) is a current page in the page movement history storing unit 104. When a user inputs ‘moving from (A−1) to (A−3)’ as in number 10, the controller 102 can store information representing an address of (A−3), and (A−3) is a current page, and relation information between (A−1) and (A−3) in the page movement history storing unit 104. When a user inputs ‘moving a domain forward’ as in number 11, the controller 102 displays a specific page (B−1) of the next root domain B of a current root domain A, on the display unit 106 with reference to the domain movement history storing unit 103, and stores information representing B is a current root domain in the domain movement history storing unit 103. In addition, the controller 102 stores information representing an address of (B−1), and (B−1) is a current page, and relation information between (B−1) and (A−3) in the page movement history storing unit 104.

As described above, a method for moving a page in a web browser according to an exemplary embodiment of the present invention allows a user to directly move to a web page of a root domain previously opened even without performing several operations repeatedly of moving a page backward. That is, when ‘moving a domain backward’ is input, a user can move to a web page of a root domain right previously opened, which is different from a current root domain, and when ‘moving a domain backward’ is input again, the user can move to a web page of another different root domain previously opened, so that the user can easily move on a domain basis, not known heretofore.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described exemplary embodiments but should be determined by not only the appended claims but also the equivalents thereof.

Finally, the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A method for moving to a web page in a web browser of a terminal, the method comprising:
receiving by a controller an input command related to web page movement from an input unit;
determining by the controller whether or not the received input related to the web page movement is an input related to moving backward or forward;
when the received input related to the web page movement is not the input related to moving backward or forward, comparing a current root domain with a root domain of a web page to be moved to for determining whether or not the root domain has changed;
when the root domain has changed, storing in a storing unit an address of the web page to be moved; and
moving by the browser to the web page as specified in the received input for display by a display unit.

2. The method of claim 1, further comprising, when the root domain has not changed, storing the address of the web page to be moved in a page movement history storing portion of the storing unit.

3. The method of claim 1, further comprising changing a root domain of the moved web page into a current root domain.

4. The method of claim 3, further comprising, when the received input related to the web page movement is an input related to moving a domain backward or forward, moving to a web page of a root domain previously visited with reference a domain movement history storing portion of the storing unit.

5. The method of claim 4, further comprising changing the root domain of the moved web page to be a current root domain.

6. The method of claim 4, wherein the web page of the root domain comprises a web page of an address stored in the domain movement history storing portion of the storing unit.

7. The method of claim 1, further comprising, when the received input related to the web page movement comprises a particular input command related to moving a page backward or forward, moving to a web page previously visited with reference to the page movement history storing portion of the storing unit.

8. The method of claim 7, further comprising, when the root domain of the moved web page is different from the root domain of the current web page, changing the root domain of the moved web page into a current root domain.

9. The method of claim 7, further comprising changing the moved web page into a current web page for display by the display unit.

10. The method of claim 4, where the browser moves to a previous root domain anywhere in the domain history movement without requiring multiple backward commands that sequentially display pages until a desired particular root domain from history is displayed.

11. An apparatus for moving to a web page in a web browser of a terminal, the apparatus comprising:
a memory for storing a first list for managing a root domain movement history, and a second list for managing a page movement history;
a controller for updating at least one of the first list and the second list whenever a web page access occurs, and when moving a root domain is selected by a user, directly accessing a web page of a relevant root domain with reference to the first list; and
a display unit for displaying the directly accessed web page.

12. The apparatus of claim 11, wherein when moving a page is selected by a user, the controller accesses a relevant web page with reference to the second list.

13. The apparatus of claim 11, wherein when moving a root domain is selected by a user, the controller displays the first list on the display unit, and when one of root domains on the first list is selected, directly accesses the selected root domain.

14. The apparatus of claim 13, wherein the direct access does not require multiple backward commands that sequentially display pages until a desired particular root domain from the first list is displayed.

15. The apparatus of claim 11, comprising a mobile terminal with Internet access.

16. The apparatus of claim 11, wherein the display unit also comprises a touchscreen input unit.
